(19) United States
(12) Patent Application Publication
(10) Pub. No.: US 2022/0390590 A1
(43) Pub. Date: Dec. 8, 2022

(54) TERAHERTZ IMAGING DEVICE AND METHOD FOR IMAGING AN OBJECT HIDDEN UNDERNEATH CLOTHING

(71) Applicant: INSTITUT NATIONAL D'OPTIQUE, Québec (CA)

(72) Inventors: Linda MARCHESE, Québec (CA); Alain BERGERON, Québec (CA); Marc TERROUX, Québec (CA); Michel DOUCET, Quebec (CA); François BERTHIAUME, Québec (CA); Martin BRIAND, Québec (CA); Mélanie LECLERC, Québec (CA); Fabien CLAVEAU, Québec (CA)

(21) Appl. No.: 17/776,023

(22) PCT Filed: Nov. 12, 2020
(86) PCT No.: PCT/CA2020/051536

§ 371 Date: May 11, 2022

Related U.S. Application Data
(60) Provisional application No. 62/934,761, filed on Nov. 13, 2019.

(51) Int. Cl. G01S 13/88; G01S 13/89; G01S 7/03

(52) U.S. Cl. CPC G01S 13/887; G01S 13/89; G01S 7/032

(57) ABSTRACT

There is described a terahertz (THz) imaging device and method for imaging an object hidden underneath clothing. The THz imaging device is generally configured for illuminating a region of clothing with a THz illumination beam, collecting a return optical beam reflected from the region of clothing in response to the illumination, generating a THz image based on the collected return optical beam, and tracking a position and orientation of the THz imaging device as the THz image is generated. A plurality of complementary THz images are generated by repeating the steps of illuminating, collecting, generating and tracking for a plurality of points of view of the THz imaging device relative to the clothing. By registering these THz images to one another in a common coordinate system based on the tracked position and orientation, the THz imaging device can output a composite THz image representing the hidden object, if any.

### FIELD

The improvements generally relate to terahertz (THz) imaging and more particularly relate to imaging objects hidden underneath clothing for security screening applications.

### BACKGROUND

FIG. 1 shows an example of a full body scanner generally used in primary security screenings at airports to detect metal and non-metal objects carried by a person underneath her/his clothing. The full body scanner can generate an alert when detecting an object underneath a person's clothing. Once an alert has been generated, a secondary security screening of the person is typically performed downstream from the full body scanning step. As the secondary security screening is generally based on a hand search, there remains room for improvement.

### SUMMARY

There is described a THz imaging device and a method for imaging an object hidden underneath clothing. The THz imaging device and method described herein can be advantageously used in the context of the secondary security screening discussed above, among other applications, for contactless security screening.

In an aspect, the THz imaging device has a housing with an exterior surface defining a cavity therein, one or more handles which protrude from the exterior surface, and one or more windows defined in the exterior surface. As will be described below, the window is optically transparent to THz radiation. In this disclosure, THz radiation should be interpreted as encompassing optical frequencies ranging from 200 to 600 GHz, and even a broader range in some embodiments. The THz imaging device has a THz radiation illuminator and a THz camera both mounted inside the housing. During use, the THz radiation illuminator emits a THz illumination beam across the window(s) and thereby illuminates a distant target region. The THz camera collects a return optical beam reflected from the target region and generates a THz image based on the return optical beam. Accordingly, a display mounted to the housing and communicatively coupled to the THz camera can display the THz image, which can represent a hidden object, if any. As can be understood, a secondary security screening using such a THz imaging device may be contactless, which can be preferred for at least some persons.

In a second aspect, the THz imaging device can be used to illuminate a region of a person's clothing with a THz illumination beam from a given point of view, to collect a return optical beam reflected from the region of the clothing, and more specifically from a region underneath the clothing in response to the illumination; to generate a THz image based on the collected return optical beam, and to track a position and orientation of the THz imaging device and/or of the region of the clothing. A plurality of THz images can be generated by repeating these steps for a number of points of view of the THz imaging device relative to the clothing. These THz images can be registered to one another in a common coordinate system, e.g., by reconstructing, stitching and/or blending, to output a composite THz image representing the hidden object, if any. It is intended that the composite THz image can have a satisfactory resolution allowing to distinguish articles that a person can bring with him on an aircraft from those that are prohibited, at least in some applications.

In accordance with a third aspect of the present disclosure, there is provided a method of imaging an object hidden underneath clothing, the method comprising: illuminating a region of said clothing with a THz illumination beam; collecting a return optical beam reflected from said region of said clothing in response to said illuminating; generating a THz image based on said collecting; tracking a position and orientation of said generating; repeating said illuminating, collecting, generating and tracking for a plurality of points of view of said illuminating and collecting relative to said clothing, thereby generating a plurality of THz images; and outputting a composite THz image by registering said plurality of THz images to one another in a common coordinate system based on said tracking, said composite THz image representing said hidden object, if any.

Further in accordance with the third aspect of the present disclosure, said registering can for example comprise at least one of reconstructing, stitching and blending said plurality of THz images to one another.

Still further in accordance with the third aspect of the present disclosure, the method can for example further comprise displaying said composite THz image.

Still further in accordance with the third aspect of the present disclosure, the method can for example further comprise updating said displaying at each repeating step.

Still further in accordance with the third aspect of the present disclosure, the method can for example further comprise identifying a type of said hidden object and generating an alert based on said type.

Still further in accordance with the third aspect of the present disclosure, said composite THz image can for example have a plurality of pixels, each having a corresponding intensity value, each intensity value lower than a given intensity threshold being attenuated in said THz composite image.

Still further in accordance with the third aspect of the present disclosure, said repeating can for example comprise moving said THz illumination beam from one of said points of view to another.

Still further in accordance with the third aspect of the present disclosure, said moving can for example comprise moving said THz illumination beam in a given scanning pattern.

Still further in accordance with the third aspect of the present disclosure, said illuminating can for example be performed within a field of illumination ranging from 5° to 45°.

Still further in accordance with the third aspect of the present disclosure, said collecting can for example be performed within a field of view ranging from 5° to 45°.

Still further in accordance with the third aspect of the present disclosure, said illuminating can for example be performed within a field of illumination and wherein said collecting can for example be performed within a field of view being matched to said field of illumination.

Still further in accordance with the third aspect of the present disclosure, the method can for example further comprise measuring a range value indicative of a range of said region of said clothing, said method can for example further comprise generating an alert when said range value is one of below a minimum range limit and above a maximum range limit.

Still further in accordance with the third aspect of the present disclosure, said minimum range limit can for example be equal to or above 7.5 cm and wherein said maximum range limit can for example be equal to or below 45 cm.

Still further in accordance with the third aspect of the present disclosure, said illuminating can for example comprise emitting a THz radiation beam and coherence breaking said THz radiation beam to obtain said THz illumination beam.

In accordance with a fourth aspect of the present disclosure, there is provided a THz imaging device for imaging an object hidden underneath clothing, the THz imaging device comprising: a THz radiation illuminator successively illuminating a plurality of regions of said clothing with a THz illumination beam; a THz camera collecting a plurality of return optical beams reflected from successive ones of said plurality of said regions of said clothing and generating a plurality of THz images based on said plurality of return optical beams; a tracking device producing position and orientation data indicative of a position and orientation of said THz imaging device relative to corresponding ones of said plurality of regions of said clothing; and a controller having a processor and a memory having instructions stored thereon that when executed by said processor performs a step of outputting a composite THz image by registering said plurality of THz images to one another in a common coordinate system based on said position and orientation data, said composite THz image representing said hidden object, if any.

Further in accordance with the fourth aspect of the present disclosure, the THz imaging device can for example further comprise a housing enclosing said THz radiation illuminator, said THz camera, said tracking device and said controller, said housing can for example have one or more windows being optically transparent to said THz illumination beam and one or more handles protruding from said housing.

Still further in accordance with the fourth aspect of the present disclosure, the THz imaging device can for example further comprise a display communicatively coupled to said controller, said display can for example display said composite THz image.

Still further in accordance with the fourth aspect of the present disclosure, said THz radiation illuminator can for example have a field of illumination ranging from 5° to 45° and wherein said THz camera can for example have a field of view ranging from 5° to 45°.

Still further in accordance with the fourth aspect of the present disclosure, the THz imaging device can for example further comprise a range sensor communicatively coupled to said controller and sensing a range value indicative of a range between said THz imaging device and said clothing, said controller can for example generate an alert when said range value is one of below a minimum range limit and above a maximum range limit.

Still further in accordance with the fourth aspect of the present disclosure, said THz radiation illuminator can for example further comprise a THz radiation emitter emitting a THz radiation beam and a coherence breaking device coherence breaking said THz radiation beam and outputting said THz illumination beam.

In accordance with a fifth aspect of the present disclosure, there is provided a method of imaging an object hidden underneath a surface (e.g., wall, clothing), the method comprising: illuminating a region of said surface with a THz illumination beam; collecting a return optical beam reflected from said region of said surface in response to said illuminating; generating a THz image based on said collecting; tracking a position and orientation of said generating; repeating said illuminating, collecting, generating and tracking for a plurality of points of view of the THz imaging device relative to said surface, thereby generating a plurality of THz images; and outputting a composite THz image by registering said plurality of THz images to one another in a common coordinate system based on said tracking, said composite THz image representing said hidden object, if any.

In accordance with a sixth aspect of the present disclosure, there is provided a THz imaging device for imaging an object hidden underneath a surface (e.g., wall, clothing), the THz imaging device comprising: a THz radiation illuminator successively illuminating a plurality of regions of said surface with a THz illumination beam; a THz camera collecting a plurality of return optical beams reflected from successive ones of said plurality of said regions of said surface and generating a plurality of THz images based on said plurality of return optical beams; a tracking device producing position and orientation data indicative of a position and orientation of said THz imaging device relative to corresponding ones of said plurality of regions of said surface; and a controller having a processor and a memory having instructions stored thereon that when executed by said processor performs a step of outputting a composite THz image by registering said plurality of THz images to one another in a common coordinate system based on said position and orientation data, said composite THz image representing said hidden object, if any.

In accordance with a seventh aspect of the present disclosure, there is provided a THz imaging device comprising: a housing having an exterior surface defining a cavity therein, one or more handles mounted to said exterior surface, and one or more windows defined in said exterior surface, said one or more windows being optically transparent to THz radiation; a THz radiation illuminator and a THz camera both mounted inside said housing, the THz radiation illuminator emitting a THz illumination beam across said one or more windows and illuminating a distant target region, the THz camera collecting a return optical beam reflected from said target region and generating a THz image based on said return optical beam; a display mounted to said exterior surface of said housing, said display being communicatively coupled to said THz camera and displaying said THz image. In this aspect, an operator grasps the one or more handles of the housing to move the THz illumination beam from one target region to another.

Further in accordance with the seventh aspect of the present disclosure, said THz illumination beam can for example be emitted within a field of illumination ranging from 5° to 45°, and preferably of about 25°.

Still further in accordance with the seventh aspect of the present disclosure, said THz camera can for example have a field of view ranging from 5° to 45°, and preferably of about 25°.

Still further in accordance with the seventh aspect of the present disclosure, said field of illumination of the THz radiation illuminator and said field of view of said THz camera can for example be matched to one another within a given working distance.

Many further features and combinations thereof concerning the present improvements will appear to those skilled in the art following a reading of the instant disclosure.

### DESCRIPTION OF THE FIGURES

FIG. 1 is a front plan view of an example of a primary security screening involving a full body scanner, in accordance with the prior art;

FIG. 2 is a side elevation view of an example of a secondary security screening involving an exemplary THz imaging device, in accordance with one or more embodiments;

FIG. 2A is a perspective view of the THz imaging device of FIG. 2, in accordance with one or more embodiments;

FIG. 2B is a schematic view of THz images being registered to one another in a common coordinate system, in accordance with one or more embodiments;

FIG. 2C is a schematic view of a composite THz image based on the THz images of FIG. 2B and representing an object, in accordance with one or more embodiments;

FIG. 3 is a schematic side elevation view of the THz imaging device of FIG. 2, showing a THz illuminator, a THz camera, a tracking device and a controller, in accordance with one or more embodiments;

FIG. 3A is a schematic view of the THz imaging device of FIG. 2, showing a THz illumination beam and a return optical beam, in accordance with one or more embodiments;

FIG. 4 is a schematic view of an example of a computing device of the controller of FIG. 3, in accordance with one or more embodiments;

FIG. 5 is a flow chart of a method of imaging an object hidden underneath clothing, in accordance with one or more embodiments;

FIG. 6A is an example of a THz image representing a region of a first object, in accordance with one or more embodiments;

FIG. 6B is an example of a THz composite image incorporating the THz image of FIG. 6A and representing the first object of FIG. 6A, in accordance with one or more embodiments;

FIG. 6C is an image of the first object of FIG. 6A;

FIG. 7A is an example of a composite THz image representing a second object, in accordance with one or more embodiments;

FIG. 7B is an image of the second object of FIG. 7A;

FIG. 8 is an oblique view of another example of a THz imaging device being handled by an operator, in accordance with one or more embodiments;

FIG. 8A is a top plan and sectional view of the THz imaging device of FIG. 8, in accordance with one or more embodiments;

FIG. 9 is an oblique view of another example of a THz imaging device, shown proximate to an operator, in accordance with one or more embodiments; and

FIG. 9A is an oblique and sectional view of the THz imaging device of FIG. 9, in accordance with one or more embodiments.

### DETAILED DESCRIPTION

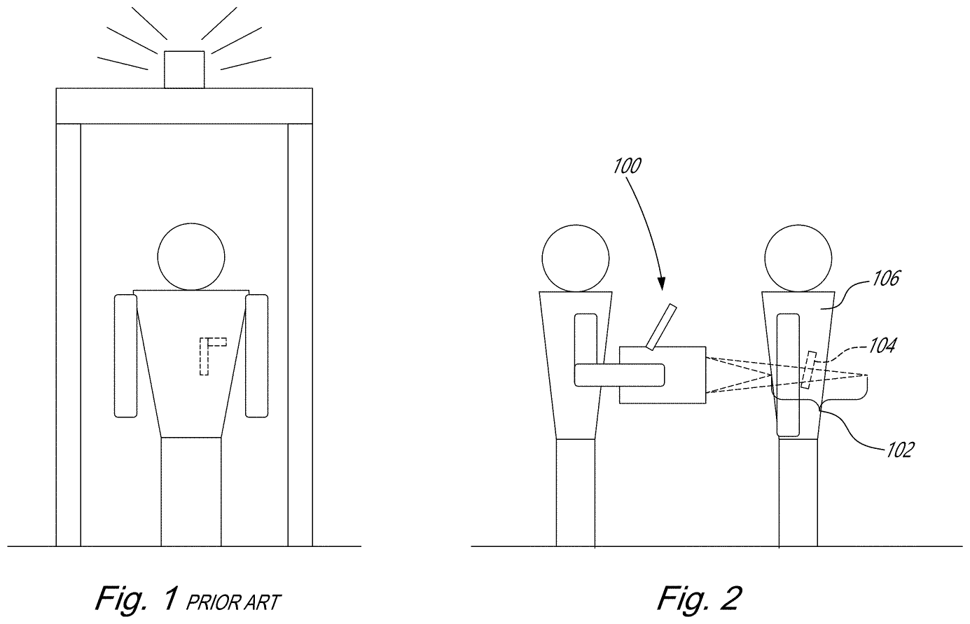

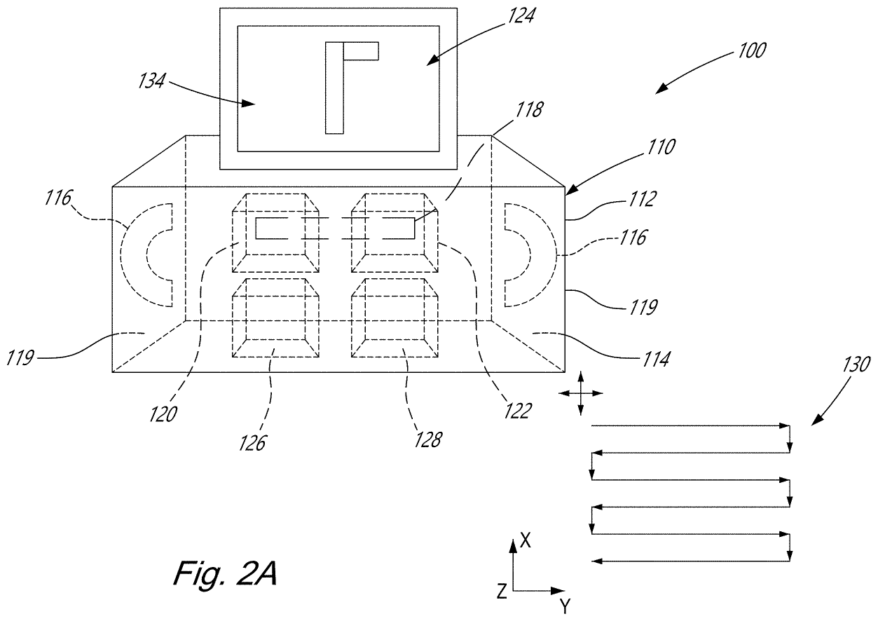

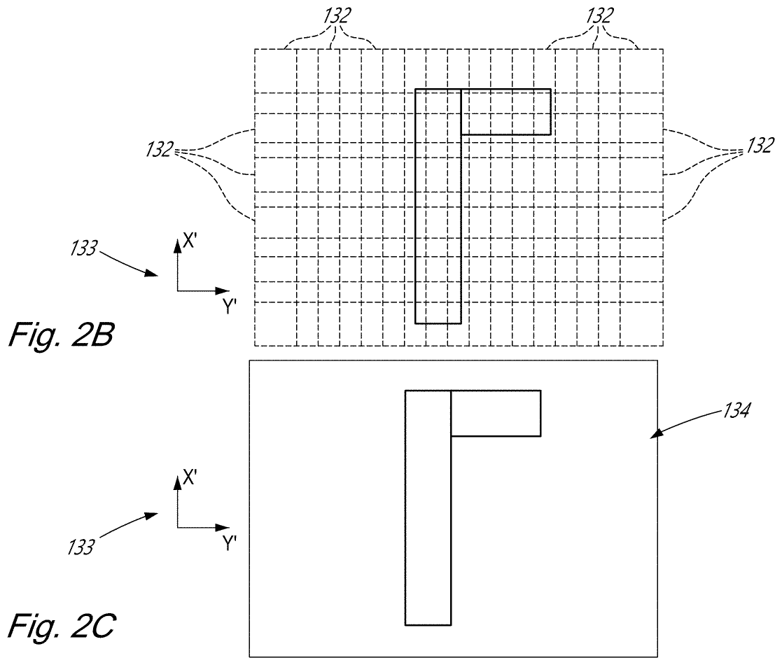

FIG. 2 shows an example of a THz imaging device 100, in accordance with an embodiment. As shown in this example, the THz imaging device 100 is used for imaging, within a predetermined working distance 102, an object 104 underneath a person's clothing 106 in a secondary security screening. However, it is envisaged that the THz imaging device 100 can be used in other contexts as well.

Referring now to FIG. 2A, the THz imaging device 100 has a housing 110 with an exterior surface 112 which defines a cavity 114 therein. The housing 110 has one or more handles 116 mounted to the exterior surface 112. In some embodiments, the handles 116 protrude from the housing 110. For instance, the handles 116 may protrude from the lateral sidewalls 119 of the housing 110. In some other embodiments, the handles 116 can be recessed in the housing 110. As can be understood, the handles 116 are designed to be handled by an operator during use. Accordingly, an operator can grab the THz imaging device 100 by its handles 116 and manipulate the THz imaging device 100 as desired during secondary security screening, for instance.

The housing 110 also has one or more windows 118 defined in the exterior surface 112. The window(s) 118 are optically transparent to THz radiation thereby allowing THz radiation to be emitted along the z-axis from the cavity 114 to a region of a person's clothing across the window(s) 118, or vice versa. Examples of materials for the window(s) 118 can include, but not limited to, high density polyethylene (HDPE), Teflon, quartz, high resistivity float zone silicon (HRFZ) and the like.

As shown in this specific example, the THz imaging device 100 has a THz radiation illuminator 120 and a THz camera 122 which are both mounted inside the housing 110. As will be further discussed below, the THz radiation illuminator 120 emits a THz illumination beam that is transmitted through the window(s) 118 and illuminates a given region of the clothing. Upon such an illumination, the THz camera 122 collects a return optical beam reflected from the region of the clothing and thereby generates a THz image based on the collected return optical beam. The return optical beam can result from a specular and/or diffuse reflection on the given region of the clothing. In this example, the THz imaging device 100 has a display 124 which is mounted to the housing 110 and which is communicatively coupled to at least the THz camera 122. During use, the display 124 displays the generated THz image. In the context of a secondary security screening, the displayed THz image can be used to determine whether there is in fact an object hidden underneath the region of the clothing. Additionally, or alternately, the type of object can also be determined by the THz imaging device 100 at least in some circumstances.

In this specific example, the THz imaging device 100 has a tracking device 126 and a controller 128 that are both mounted inside the housing 110. The tracking device 126 can produce position and orientation data indicative of a position and orientation of the housing 110 and/or the region of the clothing during imaging. The controller 128 is communicatively coupled to the THz camera 122 and to the tracking device 126. It is thus envisaged that by handling the housing 110 of the THz imaging device 100 via the handles 116 according to a given scanning pattern 130, an operator can image a number of regions of the clothing in a successive manner and thereby generate a corresponding number of THz images 132, examples of which are shown in FIG. 2B. Upon registering the THz images 132 to one another in a common coordinate system 133, the controller 128 can produce a composite THz image to be displayed on the display 124. An example of such a composite THz image is shown at 134 in FIG. 2C. The way the THz images 132 are registered to one another can differ from one embodiment to another. For instance, in some embodiments, at least some of the THz images 132 are stitched to one another. Additionally or alternatively, at least some of the THz images 132 can be blended to one another. Such registering of the THz images can be analogous as to how pictures are registered to one another to output a panoramic image using a smart phone, for instance. Other types of registering taking into account orientation and/or 3D space information may be envisaged as well.

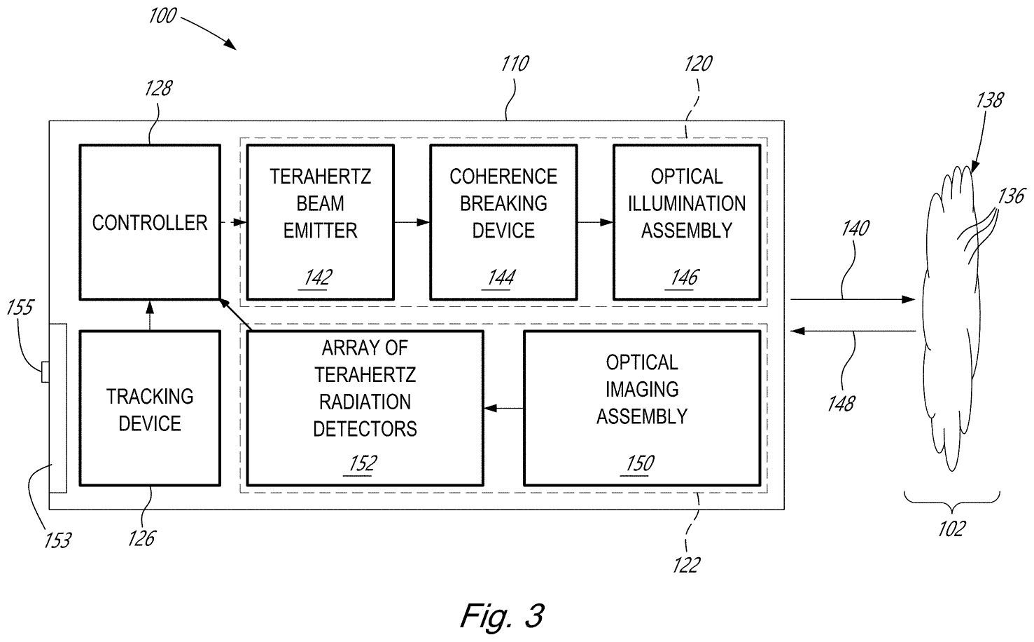

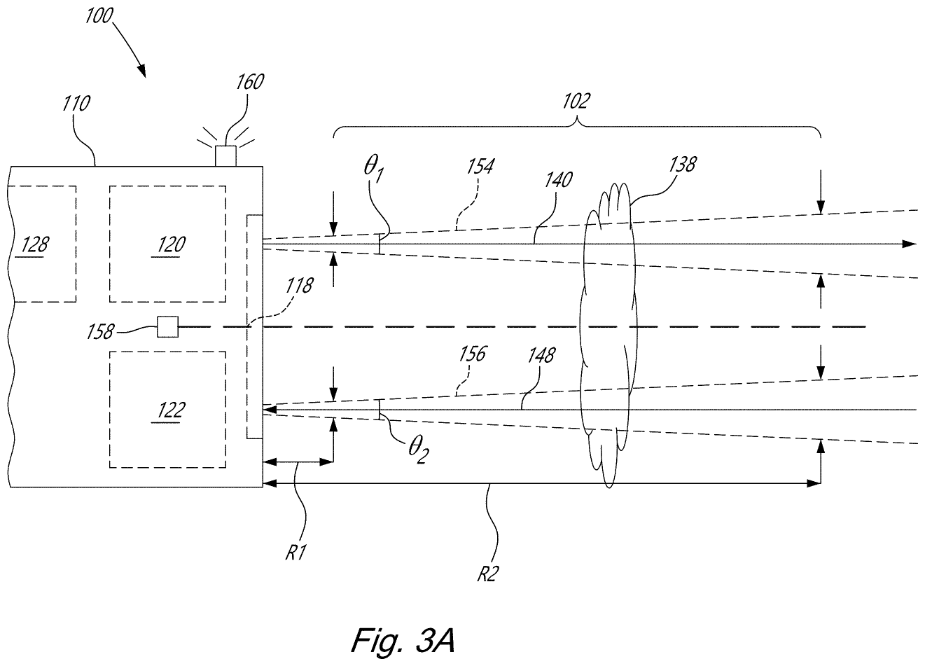

FIG. 3 shows a schematic side view of the THz imaging device 100. As shown in this specific example, the THz radiation illuminator 120 successively illuminates regions 136 of clothing 138 with a THz illumination beam 140. More specifically, in some embodiments, the THz radiation illuminator 120 has a THz radiation emitter 142 which emits a THz radiation beam, and a coherence breaking device 144 coherence breaking the THz radiation beam to provide the THz illumination beam 140. In some embodiments, the THz radiation beam is coherent. In some other embodiments, the THz radiation beam is incoherent, but nonetheless passed through the coherence breaking device 144 to ensure that the THz illumination beam 140 is as much incoherent as possible for illumination and/or speckle reduction purposes. An example of such a coherence breaking device is described in U.S. Pat. No. 10,042,172, the contents of which are hereby incorporated by reference. The THz radiation illuminator 120 can also have an optical illumination assembly 146 shaping the THz illumination beam 140 for proper propagation along the working distance 102. For instance, in some embodiments, the optical illumination assembly 146 can incorporate one or more lenses, one or more reflective surfaces, one or more polarizing filters and any other suitable optical components.

The THz camera 122 collects return optical beams 148 reflected from successive ones of the regions 136 of the clothing 138 and generates THz images based on the collected return optical beams 148. In some embodiments, the THz camera 122 has an optical imaging assembly 150 collecting the return optical beams 148 and imaging them onto an image plane. The THz camera 122 also has an array of THz radiation detectors 152 located in the image plane. In some embodiments, the array has a resolution of 10×10 pixels, preferably 100×100 pixels, and most preferably 1000×1000 pixels. The array of THz radiation detectors 152 generates a THz image from each successive return optical beam 148. More specifically, each THz radiation detector 152 may output corresponding electrical signals indicating intensity values of respective portions of any given one of the return optical beams 148. The THz images generated by the THz camera 122 thereby comprise at least the intensity values carried by these electrical signals.

The tracking device 126 produces position and orientation data indicative of a position and orientation of the THz imaging device 100 relative to corresponding ones of the regions 136 of the clothing 138. The tracking device 126 can incorporate a global positioning system (GPS) sensor, one or more accelerometers, one or more inclinometers, camera(s), one or more three-dimensional (3D) laser positioning sensor, one or more wireless positioning devices, one or more ultrasonic positioning sensors, and any other suitable sensor capable of sensing the position and orientation of the THz imaging device 100. The position and orientation that are tracked can be that of the housing 110 of the THz imaging device 100, that of the THz radiation illuminator 120, and/or that of the regions 136 of the clothing 138 that are being illuminated successively.

The controller 128 is communicatively coupled to the THz camera 122 and to the tracking device 126 in this example. The controller 128 may also be communicatively coupled to the THz radiation illuminator 120. The controller 128 is configured to output a composite THz image by registering the THz images to one another in a common coordinate system based on the position and orientation data produced by the tracking device 126. Accordingly, the outputted composite THz image can represent an object hidden under the clothing, if any. The composite THz image can be forwarded to a display, a memory and/or a distant network, depending on the embodiment.

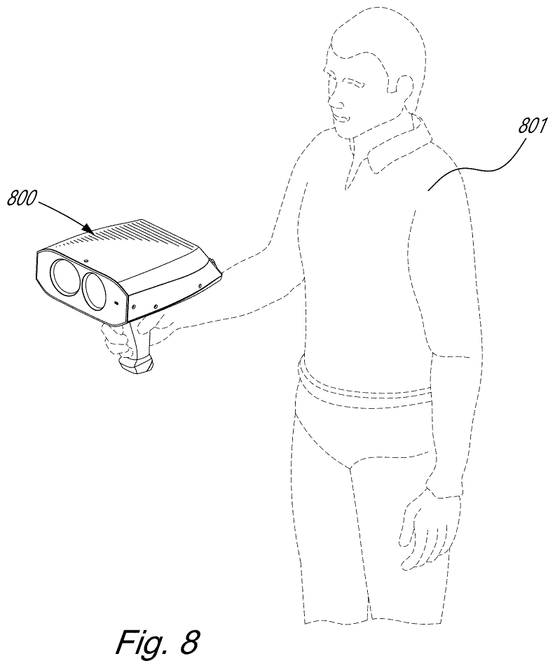

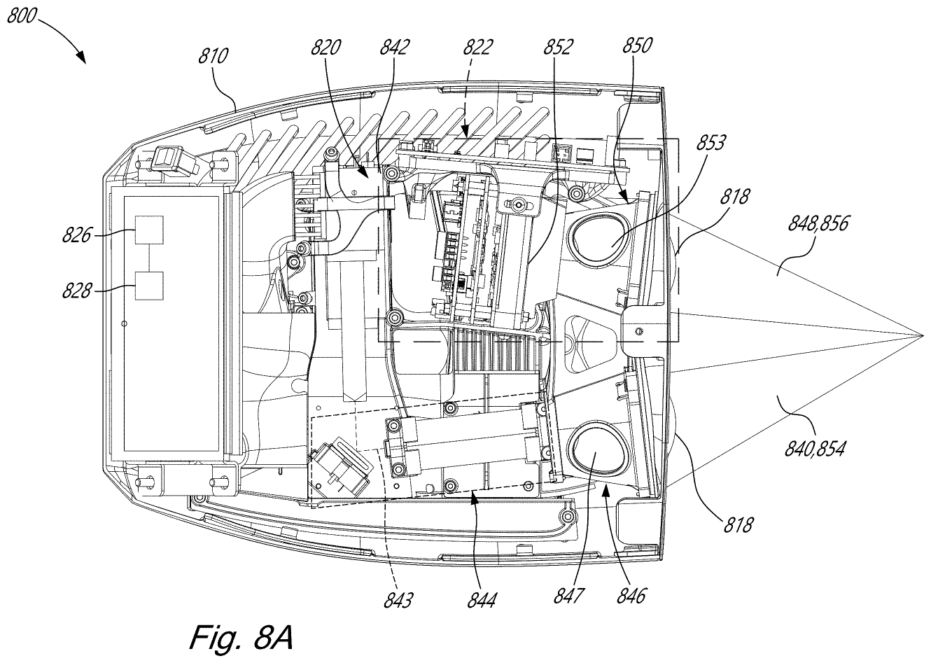

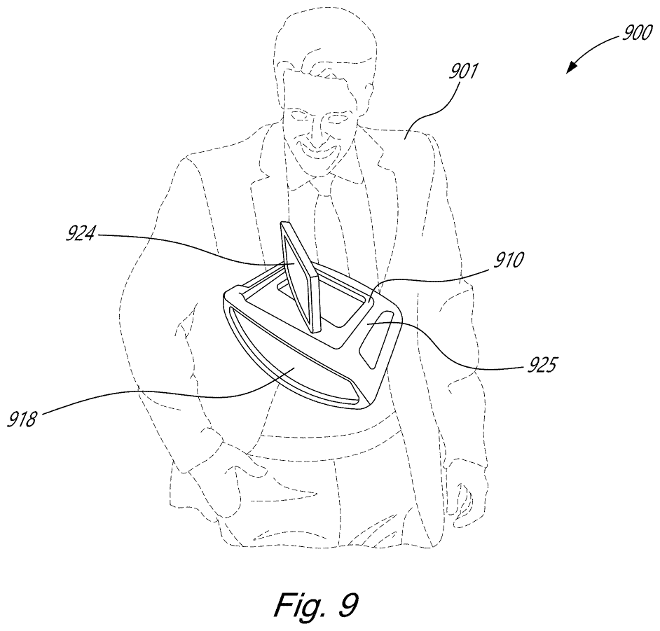

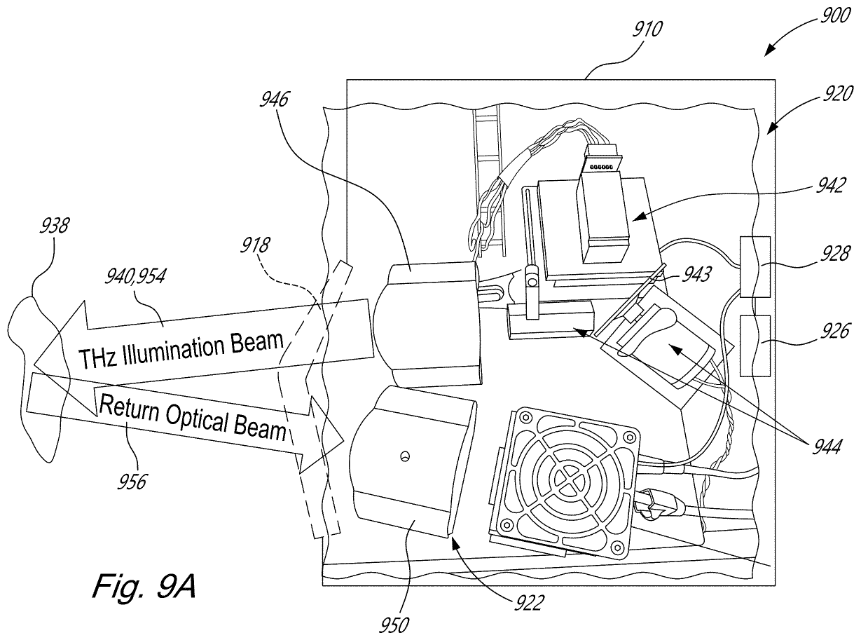

The THz imaging device 100 generally has a power supply 153 powering the THz radiation illuminator 120, the THz camera 122, the tracking device 126 and/or the controller 128. The power supply can comprise one or more batteries or battery packs. The battery(ies) or battery pack(s) can be removable and/or rechargeable, depending on the embodiment. In some embodiments, the power supply comprises a power outlet 155 to which a power cable can be connected. In such embodiments, electrical power can be drawn from an external source via the power cable at all times, or only when necessary. The battery may be omitted in some embodiments. A communication cable can also be used in some embodiments to exchange data and/or signals between the THz imaging device 100 and other devices, systems and/or networks. It is noted that the THz imaging device 100 can be provided in the form of a portable THz imaging device, examples of which are described with reference to FIGS. 8 through 9A below.

As best seen in FIG. 3A, the THz radiation illuminator 120 has a field of illumination 154 with a divergence angle θ₁ ranging between 5° and 45°, and preferably of about 25°. Similarly, the THz camera 122 has a field of view 156 with divergence angle θ₂ ranging between 5° and 45°, and preferably of about 25°. Preferably, the field of illumination 154 and the field of view 156 are matched to one another, examples of which will be discussed below with reference to FIGS. 8A and 9A. In such embodiments, when the working distance of the THz imaging device 100 is within a few feet, the region of the clothing that can be imaged at once can be a few centimeters by a few centimeters.

In the context of a THz imaging device that is to be handleable and portable, the weight and footprint of the THz radiation illuminator have to be somewhat limited, and accordingly may provide a THz illumination of limited power. To circumvent such a drawback, it was found preferable to reduce the field of illumination 154 in order to satisfactorily illuminate each region of the clothing with sufficient THz optical power. Consequently, it was also found preferable to reduce the field of view 156 as well so that the field of illumination 154 and the field of view 156 be matched to one another. This can have the drawback of providing THz images that may be too-zoomed. In this context, it was therefore found convenient to register these multiple too-zoomed THz images to one another in a common coordinate system to output a composite THz image that can have a satisfactory solid angle providing an acceptable representation of object(s) hidden underneath a person's clothing.

In some embodiments, the THz imaging device 100 has one or more range sensors 158 mounted to the housing 110. The range sensor(s) 158 can sense a range value indicative of a range of the clothing 138 relative to the housing 110 of the THz imaging device 100. The range sensor(s) 158 can be communicatively coupled to the controller 128 in this example. Examples of such range sensors can include, but not limited to, LIDAR sensor(s), laser rangefinder(s), proximity sensor(s), capacitive sensor(s) and the like. Accordingly, the controller 128 can generate an alert when the sensed range value is one of i) below a minimum range limit Rmin and ii) above a maximum range limit Rmax. In this embodiment, the minimum range limit Rmin can be 7.5 cm whereas the maximum range limit Rmax can be 45 cm. In such embodiments, the clothing 138 can be deemed to be within the working distance 102 of the THz imaging device 100 when the sensed range value is above the minimum range limit Rmin and below the maximum range limit Rmax.

Moreover, the THz imaging device 100 can have one or more indicators 160 indicating whether the currently sensed range value is within the working distance 102. The indicator(s) 160 can be different from one embodiment to another. For instance, the indicator(s) 160 can include visual and/or auditory indicators. In some embodiments, an auditory indicator can generate an auditory alert when the clothing 138 is away from the working distance 102. This auditory alert may be stopped upon sensing that the clothing 138 is now within the working distance 102. Additionally or alternately, a visual indicator can generate a visual alert when the clothing 138 is away from the working distance 102. This visual alert may be stopped upon sensing that the clothing 138 is now within the working distance 102. In some embodiments, the visual indicator can include a red light-emitting diode (LED) and a green LED. The red LED may be activated when the clothing 138 is away from the working distance 102 whereas the green LED may be activated when the clothing 138 is within the working distance 102. Accordingly, an operator can intuitively handle the THz imaging device 100 during use.

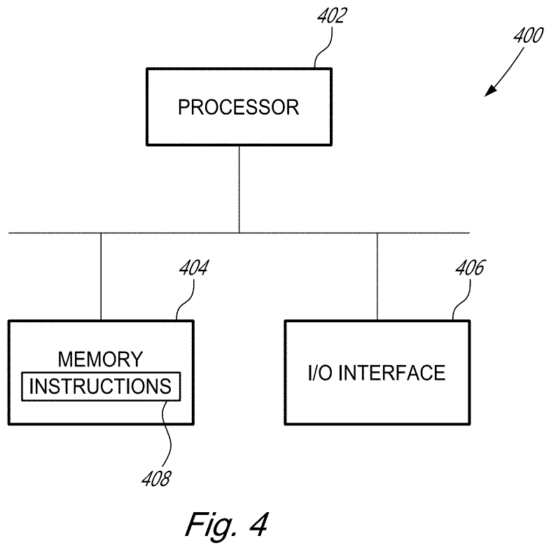

The controller 128 can be provided as a combination of hardware and software components. The hardware components can be implemented in the form of a computing device 400, an example of which is described with reference to FIG. 4. Moreover, the software components of the controller 128 can be implemented in the form of a software application.

Referring to FIG. 4, the computing device 400 can have a processor 402, a memory 404, and an I/O interface 406. Instructions 408 for imaging an object hidden underneath clothing can be stored in the memory 404 and accessible by the processor 402.

The processor 402 can be, for example, a general-purpose microprocessor or microcontroller, a digital signal processor (DSP), an integrated circuit, a field programmable gate array (FPGA), a reconfigurable processor, a programmable read-only memory (PROM), or any combination thereof.

The memory 404 can include a suitable combination of any type of computer-readable memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), ferroelectric RAM (FRAM) or the like.

The I/O interface 406 enables the computing device 400 to interconnect with one or more input devices, such as THz camera(s), range sensor(s), keyboard(s), mouse(s) and the like, and/or with one or more output devices such as THz radiation illuminator(s), display(s), indicator(s), database(s), network(s) and the like.

The I/O interface 406 enables the controller 128 to communicate with other components, to exchange data with other components, to access and connect to network resources, to server applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX, Bluetooth), SS7 signaling network, fixed line, local area network, wide area network, and others, including any combination of these.

In some embodiments, software application(s) programmed to image an object underneath clothing, and more specifically programmed to register the THz images to one another in a common coordinate system based on the position and orientation data, are stored in the memory 404 and accessible by the processor 402 of the computing device 400.

The computing device 400 described above and associated software application(s) are meant to be examples only. Other suitable embodiments of the controller 128 can also be provided, as it will be apparent to the skilled reader. For example, the controller 128 can be provided in the form of a laptop, a smart phone or an electronic tablet which is communicatively connected to a THz illuminator and camera. For instance, in some embodiments, the controller can be configured to store the outputted composite THz images in one or more databases for subsequent annotating thereof, thereby generating a truth value database with which identification engine(s) can be machine-trained over time. In some embodiments, the controller incorporates a machine-trained identification engine which can identify a type of hidden object in a composite THz image without any human intervention.

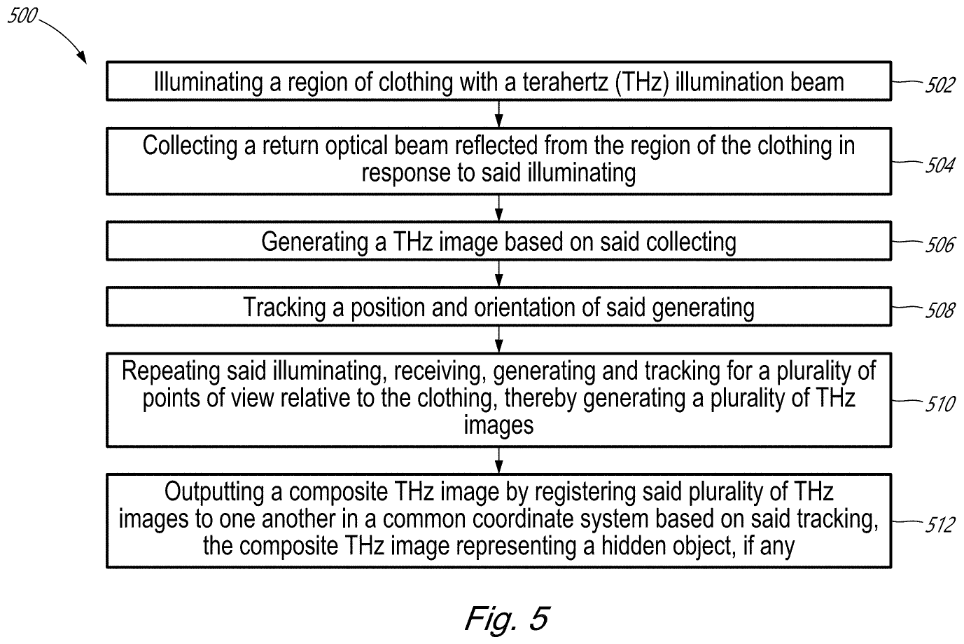

FIG. 5 shows an example of a method 500 for imaging an object underneath clothing.

At step 502, a region of clothing is illuminated with a THz illumination beam.

At step 504, a return optical beam reflected from the region of the clothing is collected following step 502.

At step 506, a THz image is generated based on the return optical beam collected at step 504.

At step 508, a position and orientation associated with the step 506 are tracked. For instance, the position and orientation of a housing of a THz imaging device, a THz radiation illuminator thereof, and/or the region of clothing can be tracked, depending on the embodiment.

At step 510, the steps 502, 504, 506 and 508 are repeated for a plurality of points of view of the THz imaging device relative to the clothing. Each repetition thereby provides a corresponding one of a plurality of THz images.

It is understood that when repeating the step 502, the THz illumination beam can be moved from one point of view to another. In some embodiments, it was found convenient to move the THz illumination beam in a given scanning pattern. An example of such a scanning pattern is the raster scan, in which the THz illumination beam is scanned horizontally on the clothing, then moved vertically, and so forth, until a satisfactory region of the clothing is scanned.

At step 512, a composite THz image is outputted by registering the THz images to one another in a common coordinate system based on the tracking of steps 508. Such registering may comprise at least one of reconstructing, stitching and blending the THz images to one another. As can be expected, the composite THz image represents a hidden object, or a portion thereof, if any.

The method 500 can include an optional step of displaying the composite THz image. Such step of displaying can be updated at each repetition of the method 500, in order to display the current composite THz image at all times. The method 500 can include a step of identifying a type of hidden object represented in the composite THz image, if any, and a step of generating an alert based on the identified type. Examples of such types can include, but not limited to, metal objects, non-metal objects (e.g., carbon fiber, polymer), sharp objects and the like.

In some embodiments, it may be preferred to actively ensure that the composite THz image does not show biological tissue of the person wearing the clothing, and instead focus on any non-organic objects. In this purpose, the wavelength of the THz illumination beam is chosen so that it is absorbed by the biological tissue, e.g., absorbed by water, while being reflected by non-biological materials. Moreover, the intensity values of the pixels of the composite THz image may be compared to an intensity threshold. When a given intensity value is lower than the intensity threshold, the given intensity value is attenuated (e.g., reduced, nulled). When performed for all pixels, any subtle representation of the biological tissue of the person in the composite THz image may be attenuated or removed, thereby circumventing any privacy issues that could otherwise occur. In some embodiments, an offset value is subtracted from each one of the intensity values detected by the THz radiation detectors. For example, an offset of 100 pW can be removed from a 1000 pW reading for all pixels.

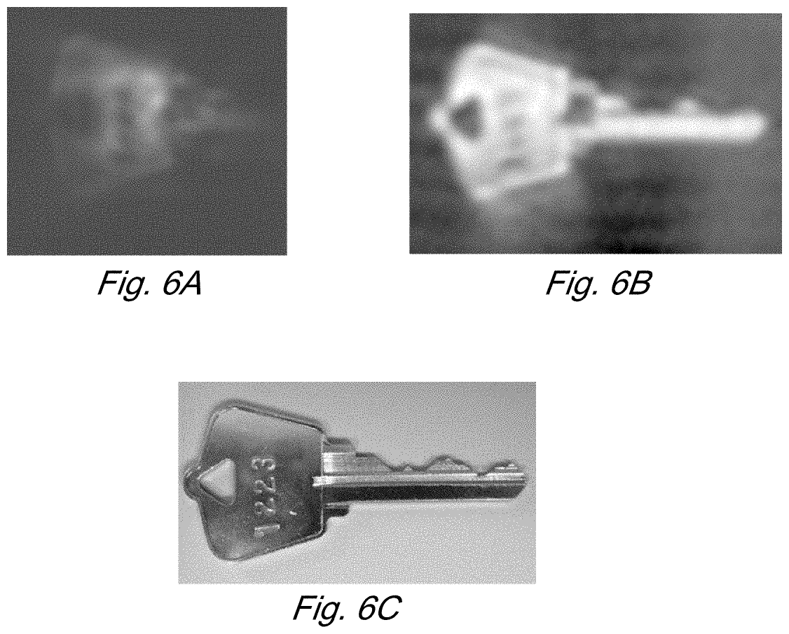

FIG. 6A is an example of a THz image representing a part of a first object. As shown, the first object is barely identifiable. FIG. 6B shows a THz composite image in which the THz image of FIG. 6A and many other THz images of surrounding parts of the first object have been registered to one another in a common coordinate system. As a result, the registration step allows easy recognition of the first object as a key, an image of the object captured with visible light being shown in FIG. 6C.

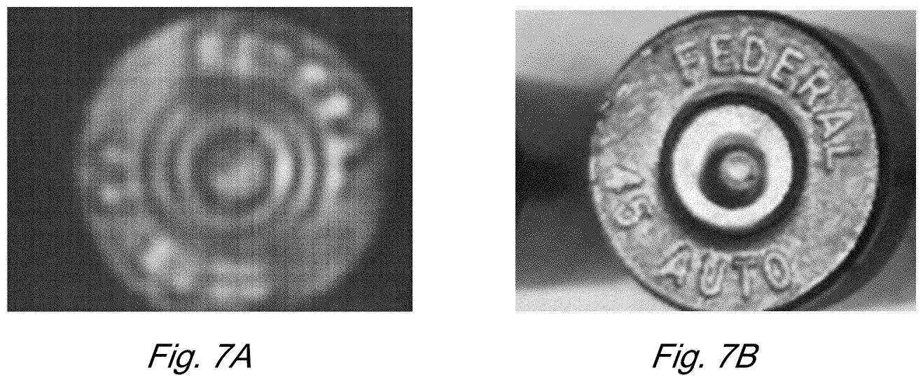

FIG. 7A is an example of a composite THz image representing a second object. It can be appreciated from FIG. 7A that the second object represents the rear end of a bullet. FIG. 7B shows an image of the rear end of the bullet captured with visible light, showing its rim and primer.

FIG. 8 shows an example of a THz imaging device 800, in accordance with another embodiment. As shown, the THz imaging device 800 has a form factor which allows an operator 801 to handle the THz imaging device 800 in secondary security screening tasks, to name only one example.

FIG. 8A shows a schematic view of the THz imaging device 800. As depicted, the THz imaging device 800 has a housing 810 inside which are mounted a THz radiation illuminator 820, a THz camera 822, a tracking device 826 and a controller 828. The housing 810 has two windows 818 which are optically transparent to THz radiation.

The THz radiation illuminator 820 has a THz radiation emitter 842 emitting a THz radiation beam 843 towards a coherence breaking device 844. The coherence breaking device 844 receives the THz radiation beam 843 and coherence breaks it to provide the THz illumination beam 840. The THz radiation illuminator 820 has an optical illumination assembly 846 having a first lens holder 847 holding one or more lenses which transmit(s) the THz illumination beam 840 towards a target region.

The THz camera 822 has an optical imaging assembly 850 having a second lens holder 853 holding one or more lenses which direct(s) the collected return optical beam 848 towards the array of THz radiation detectors 852. In some embodiments, some of the components of the optical illumination assembly 846, such as a beam splitter, can also be part of the optical imaging assembly 850. In such a configuration, the field of illumination 854 of the THz radiation illuminator 820 is matched to the field of view 856 of the THz camera 822.

In this particular embodiment, the THz imaging device 800 is configured to operate within a working distance ranging from 20 cm to 25 cm. To ensure that the imaged region be satisfactorily within the working distance, the THz imaging device 800 may include a range sensor measuring a range value indicative of a range of the imaged region. In this embodiment, the controller 828 may be configured to generate an alert when the currently measured range is below 7.5 cm or greater than 45 cm. In some preferred embodiments, the alert may be generated when the measured range is below 20 cm or greater than 25 cm.

FIG. 9 shows an example of a THz imaging device 900, in accordance with another embodiment. As shown, the THz imaging device 900 has a form factor which allows an operator 901 to handle the THz imaging device 900 in secondary security screening tasks. In this specific embodiment, the THz imaging device 900 has a display 924 mounted to a housing 910. As shown, the display 924 can be flippable between a rest position in which the display 924 lies parallel to a top surface 925 of the housing 910, and a display position in which the display 924 is perpendicular to the top surface 925.

FIG. 9A shows a schematic view of the THz imaging device 900. As depicted, the THz imaging device 900 has a housing 910 inside which are mounted a THz radiation illuminator 920, a THz camera 922, a tracking device 926 and a controller 928. The housing 910 has an elbowed window 918 which is optically transparent to THz radiation.

The THz radiation illuminator 920 has a THz radiation emitter 942 emitting a THz radiation beam 943 towards a coherence breaking device 944. The coherence breaking device 944 receives the THz radiation beam 943 and coherence breaks it to provide the THz illumination beam 940. The THz radiation illuminator 920 has an optical illumination assembly 946 comprising at least a combination of lenses.

The THz camera 922 has an optical imaging assembly 950 comprising a combination of lenses as well. As shown, the field of illumination 954 and the field of view 956 are matched to one another while pointing along different directions with respect to the clothing 938. In some embodiments, it is envisaged that the optical imaging assembly 950 can be auto-focusing, thereby always having the region to image into focus.

As can be understood, the examples described above and illustrated are intended to be exemplary only. For instance, although the THz camera discussed above is a two-dimensional (2D) THz camera generating 2D THz images, three-dimensional (3D) THz cameras generating 3D THz images could alternatively be used. For instance, such 3D THz cameras could incorporate two or more 2D THz cameras operated in a stereoscopic fashion, or equivalently involve an array of THz radiation time-of-flight detectors. Moreover, it will thus be understood that, in view of the above-described embodiments, the field of illumination and the field of view of a THz imaging device according to the present disclosure can share a common optical channel, or be directed along two different, spaced-apart optical channels. In some embodiments, the display and/or the controller can be remote from the housing of the THz imaging device. In these embodiments, the display and/or the controller can be communicatively coupled to the THz camera and/or the tracking device via wired and/or wireless communication. It is noted that the display, the controller and/or the tracking device can be omitted in some examples. In further embodiments, the THz imaging device may be attached at a distal end of an articulated arm for fast and precise scanning of a remote target. The scope is indicated by the appended claims.

What is claimed is:

1. A method of imaging an object hidden underneath clothing, the method comprising:
illuminating a region of said clothing with a terahertz (THz) illumination beam;
collecting a return optical beam reflected from said region of said clothing in response to said illuminating;
generating a THz image based on said collecting;
tracking a position and orientation of said generating;
repeating said illuminating, collecting, generating and tracking for a plurality of points of view of said illuminating and collecting relative to said clothing, thereby generating a plurality of THz images; and
outputting a composite THz image by registering said plurality of THz images to one another in a common coordinate system based on said tracking, said composite THz image representing said hidden object, if any.

2. The method of claim 1 wherein said registering comprises at least one of reconstructing, stitching and blending said plurality of THz images to one another.

3. The method of claim 1 further comprising displaying said composite THz image.

4. The method of claim 3 further comprising updating said displaying at each repeating step.

5. The method of claim 1 further comprising identifying a type of said hidden object and generating an alert based on said type.

6. The method of claim 1 wherein said composite THz image has a plurality of pixels each having a corresponding intensity value, each intensity value lower than a given intensity threshold being attenuated in said THz composite image.

7. The method of claim 1 wherein said repeating comprises moving said THz illumination beam from one of said points of view to another.

8. The method of claim 7 wherein said moving comprises moving said THz illumination beam in a given scanning pattern.

9. The method of claim 1 wherein said illuminating is performed within a field of illumination ranging from 5° to 45°.

10. The method of claim 1 wherein said collecting is performed within a field of view ranging from 5° to 45°.

11. The method of claim 1 wherein said illuminating is performed within a field of illumination and wherein said collecting is performed within a field of view being matched to said field of illumination.

12. The method of claim 1 further comprising measuring a range value indicative of a range of said region of said clothing, said method further comprising generating an alert when said range value is one of below a minimum range limit and above a maximum range limit.

13. The method of claim 12 wherein said minimum range limit is equal to or above 7.5 cm and wherein said maximum range limit is equal to or below 45 cm.

14. The method of claim 1 wherein said illuminating comprises emitting a THz radiation beam and coherence breaking said THz radiation beam to obtain said THz illumination beam.

15. A terahertz (THz) imaging device for imaging an object hidden underneath clothing, the terahertz imaging device comprising:
a THz radiation illuminator successively illuminating a plurality of regions of said clothing with a THz illumination beam;
a THz camera collecting a plurality of return optical beams reflected from successive ones of said plurality of said regions of said clothing and generating a plurality of THz images based on said plurality of return optical beams;
a tracking device producing position and orientation data indicative of a position and orientation of said THz imaging device relative to corresponding ones of said plurality of regions of said clothing; and
a controller having a processor and a memory having instructions stored thereon that when executed by said processor performs a step of outputting a composite THz image by registering said plurality of THz images to one another in a common coordinate system based on said position and orientation data, said composite THz image representing said hidden object, if any.

16. The THz imaging device of claim 15 further comprising a housing enclosing said THz radiation illuminator, said THz camera, said tracking device and said controller, said housing having one or more windows being optically transparent to said THz illumination beam and one or more handles protruding from said housing.

17. The THz imaging device of claim 15 further comprising a display communicatively coupled to said controller, said display displaying said composite THz image.

18. The THz imaging device of claim 15 wherein said THz radiation illuminator has a field of illumination ranging from 5° to 45° and wherein said THz camera has a field of view ranging from 5° to 45°.

19. The THz imaging device of claim 15 further comprising a range sensor communicatively coupled to said controller and sensing a range value indicative of a range between said THz imaging device and said clothing, said controller generating an alert when said range value is one of below a minimum range limit and above a maximum range limit.

20. The THz imaging device of claim 15 wherein said THz radiation illuminator comprises a THz radiation emitter emitting a THz radiation beam, and a coherence breaking device coherence breaking said THz radiation beam and outputting said THz illumination beam.
